(19) United States
(12) Patent Application Publication
(10) Pub. No.: US 2016/0091865 A1
(43) Pub. Date: Mar. 31, 2016

(54) TIME ZONE NOTIFICATION

(71) Applicant: Lenovo (Singapore) Pte. Ltd., Singapore (SG)

(72) Inventors: Arnold S. Weksler, Raleigh, NC (US); John Carl Mese, Cary, NC (US); Nathan J. Peterson, Durham, NC (US); Russell Speight VanBlon, Raleigh, NC (US)

(21) Appl. No.: 14/502,351

(22) Filed: Sep. 30, 2014

(51) Int. Cl. G04G 9/00

(52) U.S. Cl. CPC G04G 9/0076

(57) ABSTRACT

One embodiment provides an information handling device, comprising: an output device; a processor operatively coupled to the output device; and a memory device that stores instructions executable by the processor to: obtain data including a time associated with a location of an entity; and provide, using the output device, a notification, wherein the notification comprises the data including a time associated with a location of the contact. Other aspects are described and claimed.

### BACKGROUND

The number of people who have information handling devices, for example, a smart phone, personal computer, tablet, and the like, has increased over the years. The portability of these devices has allowed users to connect with others all over the world regardless of where the user may be located. Due to this increase in availability, people may send communications, for example, emails, phone calls, text messages, video chat, social media posts, and the like, expecting the recipient to respond within a short time frame. However, the recipient may be in a time zone that is substantially different than that of the sender. Alternatively, a sender may not know that the recipient is in a different time zone because the recipient is traveling.

### BRIEF SUMMARY

In summary, one aspect provides an information handling device, comprising: an output device; a processor operatively coupled to the output device; and a memory device that stores instructions executable by the processor to: obtain data including a time associated with a location of an entity; and provide, using the output device, a notification, wherein the notification comprises the data including a time associated with a location of the contact.

Another aspect provides an information handling device, comprising: a processor; and a memory device that stores instructions executable by the processor to: receive a query, wherein the query requests data including a time associated with a location of the information handling device; and send data, in response to the query, including a time associated with a location of the information handling device.

A further aspect provides a method, comprising: obtaining, using a processor, data including a time associated with a location of an entity; and providing, using an output device, a notification, wherein the notification comprises the data including a time associated with a location of the contact.

A further aspect provides a product, comprising: a storage device having code stored therewith, the code being executable by the processor and comprising: code that obtains, using a processor, data including a time associated with a location of an entity; and code that provides, via an output device, a notification, wherein the notification comprises the data including a time associated with a location of the contact.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of time zone notification.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The increase in the mobility of information handling devices, for example, smart phones, laptop computers, tablets, and the like, has allowed people to connect in a variety of locations. With this increase, people tend to expect that a communication (e.g., text message, phone call, email, social media post, video chat request, etc.) will be answered fairly quickly. However, a sender may not be sensitive to the time zone of the recipient. For example, the recipient may be permanently located in a time zone that is different from the sender. Alternatively, with the increase in business and pleasure traveling to other countries, it may be hard to keep track of the time zone a recipient is located within. Due to these time zone differences, the communications may be received while the recipient is sleeping or at some other less than opportune time. Some people may know what time zone an entity (e.g., individual, business, etc.) is located within, but may not know the difference in time. For example, a user may know that an entity is in the Pacific Time Zone. The user may even know that the time difference is 3 hours. However, they do not know or remember that it is 3 hours behind.

Accordingly, an embodiment provides an information handling device which may obtain data including the time zone of an entity. The information handling device may then provide a notification indicating the current time of the entity. In one embodiment, the notification may include updating information associated with the entity. For example, if an entity is included in a contact list, when the user is looking at the list, the information included in the list may include the current time of a contact. One embodiment notifies the user of the time zone when the user creates or sends a communication (e.g., text message, email, phone call, video chat, etc.).

In one embodiment, the data may be obtained in conjunction with a person sending (i.e., sender) a communication to an entity. For example, if a sender dials a phone number an embodiment may determine where the information handling device associated with that phone number is currently located and may provide that information to the sender. One embodiment may, upon informing the sender of the time zone, prevent the communication from being sent to the recipient. Alternatively or additionally, one embodiment, upon informing the sender of the time zone, may request that the sender confirm that the communication should still be sent. In an embodiment, the sender may configure their notification system. For example, a sender may request to be notified if a communication is being attempted when the recipient is in a time zone where the time is between 10:00 p.m. and 6:00 a.m.

An alternative embodiment may receive a query including a request for data including the time zone of the entity. In response to this request an embodiment may send the requested data. This query may, in one embodiment, be received in conjunction with a communication. Upon receipt of the communication, an embodiment may intercept the communication and prevent the receipt of the communication by the recipient. In one embodiment the communication may then be provided to the recipient at a more opportune time. One embodiment may provide the requested data and in addition may provide a notification stating that the communication was not received by the intended recipient. This notification system may be configurable by the user in one embodiment. For example, a user may wish for the information handling device to intercept communications between particular times.

The illustrated example embodiments will be best understood by reference to the figures. The following description is intended only by way of example, and simply illustrates certain example embodiments.

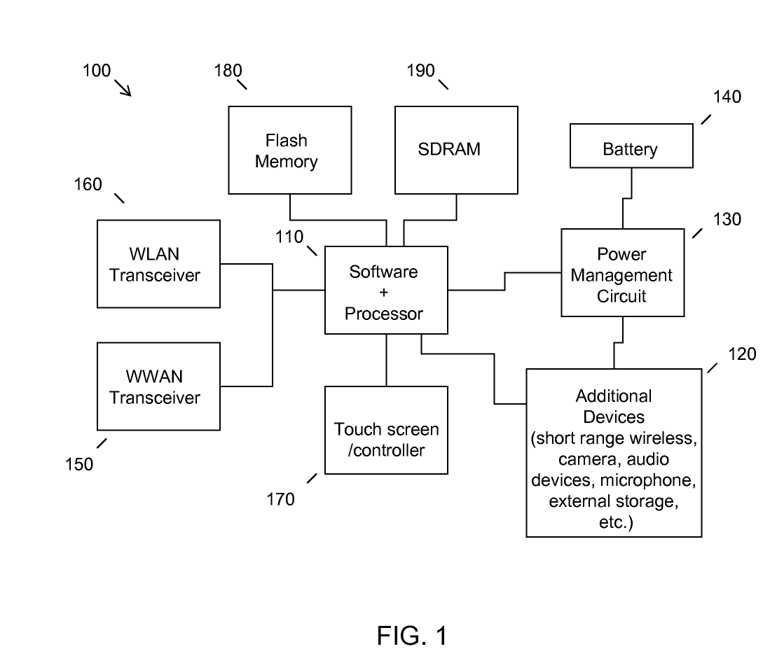

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

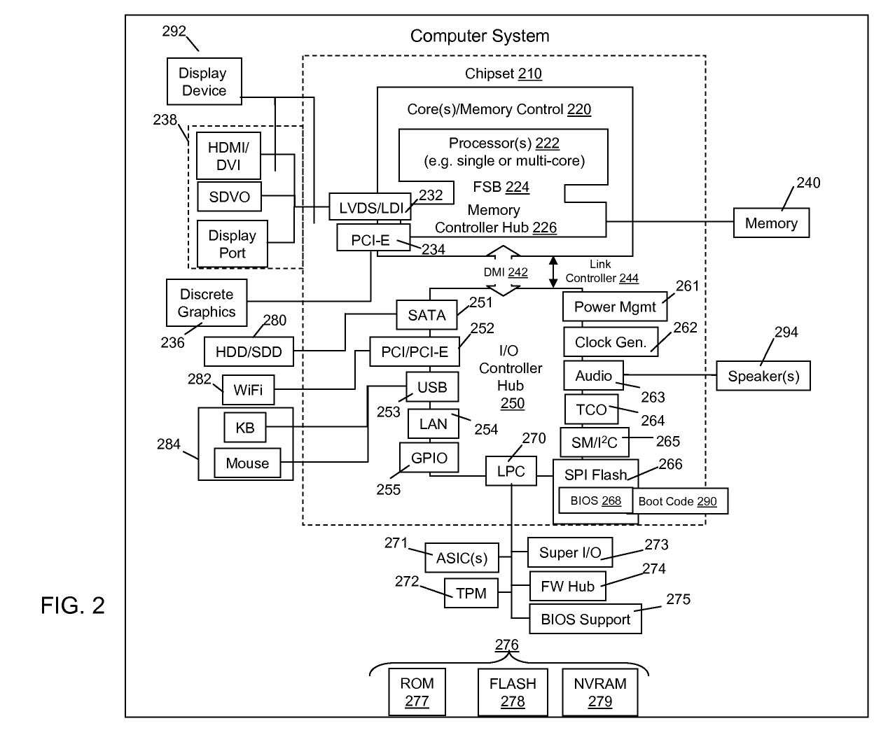

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to stay connected to others. For example, the circuitry outlined in FIG. 1 may be implemented in a tablet or smart phone embodiment, whereas the circuitry outlined in FIG. 2 may be implemented in a personal computer embodiment.

Information handling devices, such as those shown in FIG. 1 and FIG. 2, may be used by a user to communicate with others. In one embodiment, an information handling device may obtain data including a time associated with a location of an entity. The processor, for example, 110 or 222, may obtain the data, which may be obtained in a variety of ways. For example, an information handling device may use a processor 110 or 222 to send a query, for example using a WLAN transceiver 160 or WWAN transceiver 150 to connect to a network, to determine where an information handling device associated with a contact may be located. In one embodiment, the data may be received from the information handling device, or may, alternatively, be received from the network on which the information handling device is connected. For example, a smart phone may know, using methods such as GPS, cell phone tower location, and the like, the time zone of its current location. Likewise, a cell phone provider may have access to and provide this data. An another example, the data may be obtained from a calendar associated with an entity. For example, an embodiment may obtain data from a calendar and determine that the entity's calendar indicates they are to be in China during this time.

The data obtained may, in one embodiment, include a variety of information. For example, the data may include the time zone that the information handling device associated with the entity is currently located within. An embodiment may then use this information to determine the local time of the entity (e.g., individual, business, etc.). For example, an embodiment may obtain data from the information handling device associated with the entity indicating the time zone of the device's current location. Alternatively or additionally, the data obtained may include the location of the entity. For example, the data obtained may just indicate the entity is in Japan as opposed to the time zone of Japan. In another example embodiment, the data obtained may include the current time of the entity. For example, the data may indicate the time at the location of the entity is 2:00 p.m. rather than indicating either the location or the time zone. Other data may be obtained to indicate the time at the location of the entity. For example, the data may just indicate the time difference. In one embodiment a combination of data may be obtained. Additionally or alternatively, a user may configure the data to be provided. For example, a user may choose to only show the time rather than the location.

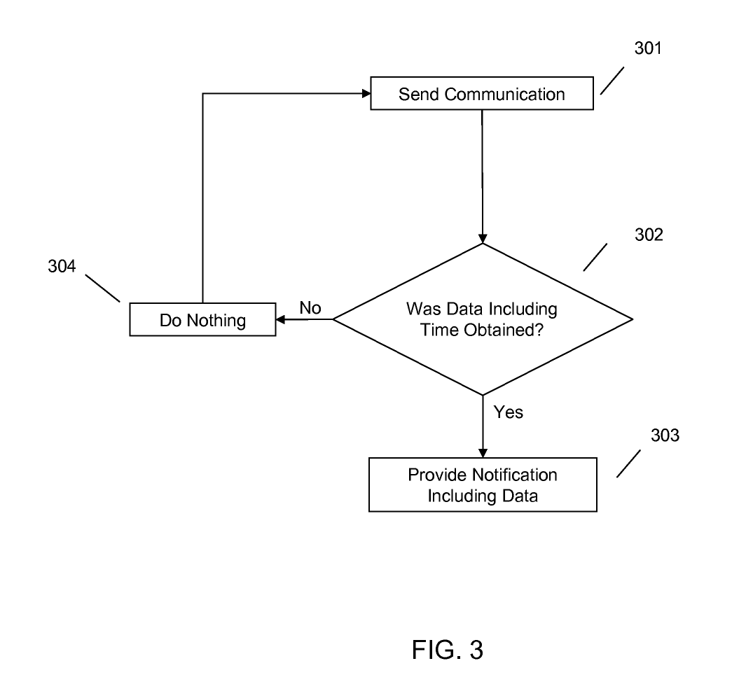

While in one embodiment the obtaining of the information occurs without an input from the user, one embodiment may obtain the data in response to a user providing an input. As an example embodiment, referring to FIG. 3, a user may send a communication (e.g., email, text message, social media post, phone call, video chat request, meeting request, etc.) to an entity at 301. In response to or in conjunction with this communication, an embodiment may obtain data including the time at the location of the entity at 302. For example, a user may send an email to an entity. When or after sending the email, the information handling device may obtain data including the current time of where the entity is located. Alternatively or additionally, the obtaining of the information may occur when a user selects an entity. This selecting may occur when the user chooses an entity from a contact list or when the user enters an entities information (e.g., phone number, email address, etc.) into the information handling device. If the data including the time is not obtained at 302, an embodiment may do nothing at 304 and wait until another communication is sent at 301.

One embodiment may prevent the sending of the communication after obtaining the data regarding the current time of the entity. This prevention may be in response to a user configured setting. For example, a user may configure the information handling device to prevent sending communications if the recipient's current time is between 11:00 p.m. and 9:00 a.m. In one embodiment, this setting may be configurable, for example, by device, by entity, by group of entities, and the like. For example, all communications sent from a user's smart phone may have one setting, while the user's computer has another setting. Alternatively, a user may set a particular entity or all family members to receive communications all the time, but all other entities to receive them only between the hours of 9:00 a.m. and 5:30 p.m. Alternatively or additionally, an information handling device may have a default setting.

One embodiment may obtain the data associated with the time of the entity and may thereafter request the user to confirm that the communication should be sent. This request may occur after the data is obtained, or, additionally or alternatively, may occur after the sending of the communication has been prevented. For example, a user may receive the request after the user has attempted to place a phone call and the phone call was prevented. Alternatively, rather than a request to confirm the sending of the communication, a user may receive a notification indicating that the communication was not sent. The notification may additionally include an indication that if the user would like the communication to be sent the user must enter a code, send the communication again within a specified amount of time, or some other type of user input.

After obtaining the data including a time associated with the location of the entity, an information handling device may provide a notification, using an output device 170 or 292 (e.g., display device, audio output device, etc.). In the example embodiment, this notification would be provided at 303. This notification may include the time associated with the location of the entity. Alternatively or additionally, the notification may include the current location of the entity or the current time zone of the entity. In one embodiment this notification may not include the exact time, time zone, or location of the entity, but rather may just indicate that the entity is in a location where the time is, for example, between 10:00 p.m. and 6:00 a.m. This notification may be provided in a variety of forms, for example, as a pop-up display, text message, voice recording, audio output, and the like.

In one embodiment, the providing may include updating information associated with the entity using the obtained data. For example, a user may have an entity saved as a contact within a contact list. When the user views the contact, the information included in the list may include the current time of the contact. In one embodiment, a user may configure this obtaining data and providing notifications to occur for a specific entity or a group of entities. For example, a user may group contacts (e.g., family, friends, coworkers, businesses, etc.). A user may then select a group for which data may be obtained. Alternatively, an embodiment may obtain data for all entities, but the user may select a group for which notifications should be provided. As an alternative embodiment, rather than a user selecting a group, an embodiment may only obtain data for a group of entities, and thereafter provide the data for that group of entities. For example, an embodiment may only update information for individuals. Likewise, an embodiment may only obtain information for a group of entities.

In one embodiment, the providing may occur when the user selects an entity. For example, if a user is sending a text message, when the user selects the entity to put in the “To:” field, the user may be provided with a notification stating the entity included on the text message is located within a particular time zone. As another example, if a user is making a phone call, when the user enters the phone number, the user may be provided with a notification. Alternatively, if a user is making a phone call, when the user presses send the user may be provided with the notification.

In an alternative embodiment, an information handling device may receive (e.g., over a wired connection, over a wireless connection, etc.) a query requesting data including a time associated with a location of the information handling device. This query may stand alone (i.e., just a query) or may be in conjunction with a communication. After receiving the query, the information handling device may, in one embodiment, send data including the time associated with the current location of the information handling device. This data may include the same information and configurability as described above (e.g., the location, current time at the location, time zone of the location, etc.).

In one embodiment, if the query is received in conjunction with a communication, the information handling device may prevent the receipt of the communication. A user may configure the prevention of receipt of communications in one embodiment. For example, the user may set the information handling device to prevent communications between a certain time frame (e.g., between 9:00 p.m. and 6:00 a.m.). As another example, a user may configure the information handling device to prevent or allow communications from a particular entity or group of entities (e.g., family, friends, coworkers, etc.). The user configured settings may be used in conjunction with each another in one embodiment. For example, a user may configure the information handling device to prevent communications from coworkers after 5:00 p.m. Other user configurable settings may be possible, for example, the user may configure the device to prevent or allow certain types of communications (e.g., phone calls, text messages, emails, etc.).

If the information handling device prevents the receipt of the communication, the data sent may additionally include a notification indicating the communication was not received by the information handling device. One embodiment may additionally provide the communication at a later time, for example, after a certain time (e.g., 6:00 a.m., 3 hours later, etc.), which may be configured by the user. For example, the user may configure the information handling device to provide any communications where the receipt was prevented at a particular time.

Accordingly, as illustrated by the example embodiments and figures, an embodiment provides an information handling device which obtains and notifies a user of a time zone associated with an entity. In one embodiment, this notifying may comprise updating information associated with a user, or it may comprise informing a sender of the time zone when the sender attempts to communicate with an entity. In one embodiment these communications may be prevented from being sent or received. Thus, an embodiment provides an information handling device which may inform a user of the local time of the entity and allow a user to make an informed decision regarding whether they should attempt to contact the entity. For example, with the knowledge of the current time, a user may understand that they may not be receiving a return communication quickly. A user may then be able to attempt a different form of communication. An embodiment additionally provides an information handling device which may prevent communications from being received while the recipient is sleeping or at other inopportune times.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device, comprising:
an output device;
a processor operatively coupled to the output device; and
a memory device that stores instructions executable by the processor to:
obtain data including a time associated with a location of an entity; and
provide, using the output device, a notification, wherein the notification comprises the data including a time associated with a location of the entity.

2. The information handling device of claim 1, wherein the data is determined using the time zone of the location of the information handling device associated with the entity.

3. The information handling device of claim 1, wherein to provide comprises updating information associated with the entity with the obtained data.

4. The information handling device of claim 3, wherein to obtain data comprises obtaining data for more than one entity.

5. The information handling device of claim 1, wherein to obtain is in response to a user sending a communication to the entity.

6. The information handling device of claim 5, wherein the instructions are further executable by the processor to prevent the sending of the communication based upon the data.

7. The information handling device of claim 5, wherein the instructions are further executable by the processor to provide an output requesting user confirmation regarding whether the communication should be sent.

8. The information handling device of claim 1, wherein to provide a notification is in response to a user selecting a contact.

9. The information handling device of claim 1, wherein the data comprises at least one of data selected from the group consisting of: the location, current time at the location, and time zone of the location.

10. The information handling device of claim 1, wherein the output device is a device selected from the group consisting of: a display device and an audio output device.

11. An information handling device, comprising:
a processor; and
a memory device that stores instructions executable by the processor to:
receive a query, wherein the query requests data including a time associated with a location of the information handling device; and
send data, in response to the query, including a time associated with a location of the information handling device.

12. The information handling device of claim 11, wherein the query is received in conjunction with a communication.

13. The information handling device of claim 12, wherein the instructions are further executable by the processor to prevent the receipt of the communication.

14. The information handling device of claim 13, wherein the data further comprises a notification, wherein the notification indicates the communication was not received by the information handling device.

15. The information handling device of claim 13, wherein the instructions are further executable by the processor to provide the communication at a time after the receipt of the communication.

16. The information handling device of claim 1, wherein the data comprises at least one of data selected from the group consisting of: the location, current time at the location, and time zone of the location.

17. A method, comprising:
obtaining, using a processor, data including a time associated with a location of an entity; and
providing, using an output device, a notification, wherein the notification comprises the data including a time associated with a location of the entity.

18. The method of claim 17, wherein the data is determined using the time zone of the location of the information handling device associated with the entity.

19. The method of claim 17, wherein the providing comprises updating information associated with the entity with the obtained data.

20. The method of claim 17, wherein the obtaining is in response to a user sending a communication to the entity.

21. The method of claim 20, further comprising preventing the sending of the communication based upon the data.

22. The method of claim 20, further comprising providing an output requesting user confirmation regarding whether the communication should be sent.

23. The method of claim 17, wherein the providing a notification is in response to a user selecting a contact.

24. The method of claim 17, wherein the data comprises at least one of data selected from the group consisting of: the location, current time at the location, and time zone of the location.

25. A product, comprising:
a storage device having code stored therewith, the code being executable by the processor and comprising:
code that obtains, using a processor, data including a time associated with a location of an entity; and
code that provides, via an output device, a notification, wherein the notification comprises the data including a time associated with a location of the entity.
